(19) United States
(12) Patent Application Publication
(10) Pub. No.: US 2007/0131656 A1
(43) Pub. Date: Jun. 14, 2007

(54) Modified welding torch cathode for use in roughening a surface and related method

(75) Inventors: Daniel Anthony Nowak, Greenville, SC (US); David V. Bucci, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/297,409

(22) Filed: Dec. 9, 2005

(51) Int. Cl. B23K 9/24

(52) U.S. Cl. 219/75

(57) ABSTRACT

A welding torch includes a torch body and a torch head, the torch head having a plurality of torch tips arranged in a dense array.

### BACKGROUND OF THE INVENTION

This invention relates to a modified reverse transfer arc welding torch used to roughen a surface for subsequent coating.

Coatings are often applied to metallic surfaces to enhance resistance to wear, erosion, corrosion, oxidation or to lower surface temperatures. Oxidation-corrosion protection for a metal is based on the ability to diffuse protective oxide forming elements, such as aluminum and chrome to the surface. Protective high temperature oxidation coatings can be applied by thermal spray and diffusion techniques with advantages and disadvantages for each method. Thermal barrier coatings (TBC) include a bond coating at the substrate, and a ytrria, magnesia or ceria partially stabilized zirconia top coating. The zirconia top coat layer can be applied by various techniques, but is generally applied by air plasma spray (APS) or electron beam physical vapor deposition (EB-PVD). Techniques such as EB-PVD are commercially successful in the application of ceramic coatings such as stabilized zirconia to aluminide surface (PtAl, simple aluminide, aluminized MCrAlY). The EB-PVD TBC zirconia columnar microstructure is strain tolerant and is historically superior to air plasma zirconia with respect to TBC spallation life for high thermal cycle applications. Air plasma processes also produce microstructures with vertical cracks that improve strain tolerance and TBC cyclic spallation life, as disclosed previously in U.S. Pat. No. 5,830,586. Attempts to apply air plasma deposited ceramics to aluminide coating surfaces (diffusion coating on substrate or over-aluminide on MCrAlY) coatings, however, have been unsuccessful due to lack of adhesion to the smooth surface being coated.

Reverse transfer arc welding, also known as reverse polarity arc welding, has been used to remove oxides from a surface to prepare it for joining. See for example, U.S. Pat. Nos. 5,512,318; 5,466,905; and 5,462,609. In U.S. Pat. No. 6,042,898, reverse transfer arc welding is utilized to clean oxides from an MCrAlY coating, after which an alumina scale is thermally grown, followed by the application of zirconia top coat to produce a TBC.

### BRIEF DESCRIPTION OF THE INVENTION

In accordance with this invention, a reverse transfer arc-welding torch can also be used to roughen a surface for subsequent coating, but common industrial torches are not efficient in preparing large surface areas. Accordingly, this invention relates to modifications to an otherwise common torch (for example, a Tungsten Inert gas (TIG) welding torch) to effectively prepare large surface areas for subsequent coating.

More specifically, a typical TIG welding torch has a single small tip that can vary in size. This invention modifies the head of the torch to incorporate an array of small tips. The array of tips facilitates roughening large surface areas to thereby make the coating process more efficient and less costly.

In the roughening process, a reverse arc transfer welding technique is employed, utilizing, for example, argon shielding gas, but the torch is maintained at a distance (e.g., ½ inch) away from the work surface so that no welding arc is generated. The resulting ion bombardment is sufficient to roughen the work surface to the degree required to insure good adhesion of the subsequently applied coating.

Accordingly, in one aspect, the present invention relates to a welding torch comprising a torch body and a torch head, the torch head having a plurality of torch tips arranged in a dense array.

In another aspect, the invention relates to a process for roughening a surface for subsequent coating comprising: a) providing a reverse transfer arc welding torch having a torch head fitted with an array of tips; and b) moving the welding torch across the surface to be coated but without establishing a welding arc between the tips and the surface to thereby roughen the surface.

The invention will now be described in detail in connection with the drawings identified below.

### BRIEF DESCRIPTION OF THE DRAWING

FIG. 1 is a cross-section through a component having a ceramic top coat layer applied over an aluminide bond coat layer in accordance with the invention; and

FIG. 2 illustrates in schematic form, a modified welding torch in accordance with an exemplary embodiment of this invention.

### DETAILED DESCRIPTION OF THE INVENTION

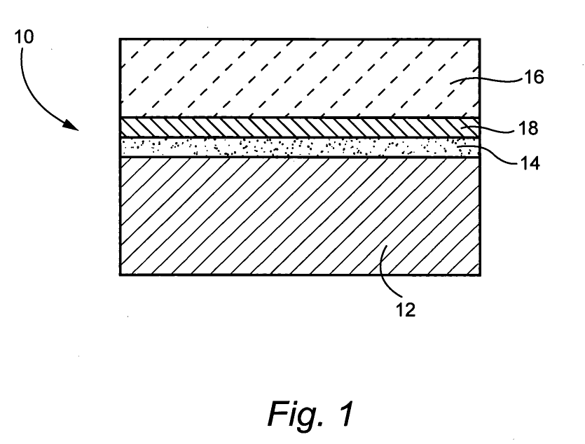

FIG. 1 illustrates a component 10 that may be a high temperature component of a gas turbine or diesel engine or any other metal article to which ceramic coatings are applied. The component 10 comprises an underlying metal substrate 12 provided with an aluminide layer 14, or bond coat, applied over the metal substrate 12. More specifically, in a preferred embodiment, the substrate is a metal alloy such as a Ni-based, Ti-based or Co-based alloy. However, substrate 12 could also be comprised of other smooth surfaces, metal alloys, e.g., PdAl, PtAl, NiAl or metal matrix composites and other plated materials, vapor deposited metallics or intermetallics and the like, so long as the substrate is capable of conducting heat sufficient to promote conditions favorable to the formation of a coherent, continuous columnar grain microstructure. Bond coat 14 may comprise of any material which promotes bonding of a top coat or TBC 16 to the substrate 12, and may include, for example, a simple aluminide, PtAl or any aluminum-rich surface layer created by diffusing aluminum into the substrate 12 or into a metallic coating on the substrate.

TBC 16 may comprise plasma-sprayed ceramic materials. In a preferred embodiment, the ceramic material is a metal oxide, such as yttria stabilized zirconia having a composition of 6-8 weight percent yttria with a balance of zirconia that is built up by APS (typically a plurality of layers). However, other TBC materials are possible including metallic carbides, nitrides and other ceramic materials.

Before the top coat 16 is applied, the surface of the bond coat is roughened as described further herein, the roughened surface indicated in exaggerated form at 18.

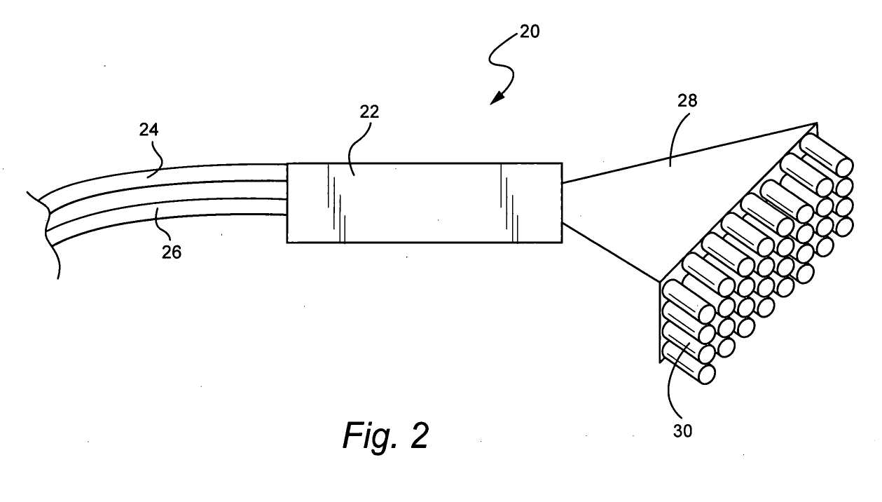

FIG. 2 illustrates in schematic form, a welding torch 20, modified particularly to suit its use in roughening the surface of bond coat 14. The torch includes a torch body 22, having power cables 24, 26 extending rearwardly therefrom, and a torch head 28. The torch head 28 is formed to include a plurality of relatively small tungsten tips 30 arranged in a dense regular array, in this case in a rectangular array of aligned rows and columns. In the example shown, four rows of eight tips are arranged parallel to one another, with the tips in each row aligned with tips in the adjacent row, thus also forming eight columns of four. Of course, the exact configuration of the array of tips may vary to suit specific applications. For example, the tips in adjacent rows may be staggered, and/or the overall shape and number of tips (e.g., from 2 to more than 100) of the array may be varied.

In use, the welding torch 20 is utilized in a reverse transfer arc process where in an otherwise normal welding process, a low amperage D.C. welding arc is established between an electrode and an electrically conductive workpiece. In the process, the electrode is at a positive electric polarity and the workpiece surface is at a negative polarity in a low current range of about 0.5-45 amps direct current. The electric polarities can also be reversed, in the same current range, between the electrode and the workpiece surface to define a polarity cycle alternating current. This reversal of polarities is repeated in a preselected pattern at a low frequency in the range of about 1-1000 cycles per second (cps). In accordance with the roughening process here, however, no welding arc is maintained due to keeping the torch a sufficient distance (for example, a half inch) away from the component 20. The torch is thus used as a high frequency generator to create shielding gas ions. As the array of tips 30 is moved across the surface area, which may be bare or coated metal, the exposed oxidized surface is roughened via ion bombardment in preparation for a subsequent coating step. The degree of roughening may vary but should achieve a roughness factor of at least 200 to 500 RA.

While described herein in the context of applying a ceramic top coat over a bond coat, the surface roughening technique disclosed herein, using a modified welding torch, can be utilized to roughen base metal or other coated substrates as well.

What is claimed is:

1. A welding torch comprising a torch body and a torch head, said torch head having a plurality of torch tips arranged in a dense array.

2. The welding torch of claim 1 wherein said dense array comprises a plurality of aligned rows and columns.

3. The welding torch of claim 2 including multiple rows and a minimum of one column.

4. The welding torch of claim 2 wherein each row contains multiple tips.

5. The welding torch of claim 4 wherein the number of tips can vary from 2 to more than 100.

6. The welding torch of claim 1 wherein the welding torch is a tungsten inert gas welding torch.

7. A process for roughening a surface for subsequent coating comprising:
a) providing a reverse transfer arc welding torch having a torch head fitted with an array of tips; and
b) moving the welding torch across the surface to be coated but without establishing a welding arc between the tips and said surface to thereby roughen said surface.

8. The method of claim 7 wherein said surface to be coated comprises a bare, plated or coated metal surface.

9. The method of claim 7 wherein said surface to be coated comprises a diffusion coating.

10. The method of claim 7 wherein said surface to be coated comprises an aluminide, PtAl, NiAl or other intermetallics.

11. The method of claim 7 wherein during step b), the surface is roughened to a roughness factor of 200 to 500 RA.

12. The method of claim 7 wherein step (a) includes providing the torch head with a dense rectangular array of tips arranged in multiple rows and columns.
